(19) United States
(12) Patent Application Publication
(10) Pub. No.: US 2007/0287004 A1
(43) Pub. Date: Dec. 13, 2007

(54) Laminate and Method of Manufacture

(76) Inventors: Andreas M. Gottzmann, Agawam, MA (US); Michel Ross, Agawam, MA (US); Aaron D. Shaw, Agawam, MA (US); Suzann M. Milheron, Agawam, MA (US)

Correspondence Address: DOHERTY, WALLACE, PILLSBURY & MURPHY, P.C., ONE MONARCH PLACE, SUITE 1900, 1414 MAIN STREET, SPRINGFIELD, MA, 01144-1900, US

(21) Appl. No.: 11/753,603

(22) Filed: May 25, 2007

Related U.S. Application Data
(60) Provisional application No. 60/803,165, filed on May 25, 2006.

(51) Int. Cl. B32B 3/26; C09J 5/02

(52) U.S. Cl. 428/322.2; 156/307.4

(57) ABSTRACT

A method for the production of a decorative laminate having an abrasion-resistant, scuff- and mar-resistant overlay, wherein the method comprises forming an overlay, wherein the method of forming the overlay comprises: impregnating a first side of a substrate with a first thermosetting resin; coating the first side of the substrate with a layer of slurry comprising a second thermosetting resin and a mix of abrasion resistant particles, wherein the mix of abrasion resistant particles comprises at least about 5 percent of elliptical, platelet shaped abrasion resistant particles to form a composite; and curing the composite to form a cured composite.

### CROSS REFERENCE TO RELATED APPLICATIONS

This application claims the benefit of U.S. Provisional Application No. 60/803,165 filed on May 25, 2006.

### BACKGROUND OF THE INVENTION

1. Field of the Invention

The present invention relates to laminates. More particularly, the invention relates to a laminate comprising an abrasion/wear, scratch-, scuff- and mar-resistant decorative, high-pressure or low-pressure surface layer having superior clarity, and to a novel process for forming the inventive laminate.

2. Background

Decorative laminates are well-known and used, for instance, as covering material for walls, cupboard doors, desktops, tabletops, and other furniture; as flooring material; etc. Such laminates are often made of two or more core paper sheets impregnated with a phenol-formaldehyde resin; a decorative paper sheet, that is either monochromatic or patterned, and that is impregnated with a melamine-formaldehyde resin; and a fine overlay sheet of alpha-cellulose impregnated with a melamine-formaldehyde resin.

The overlay sheet is intended to protect the decorative paper sheet from scratching, abrasion, scuffing and marring. Overlay sheets have been used over decorative surfaces for years to provide protection against wear and tear. The principal technology for the high-pressure laminate (HPL) industry has been to use an overlay sheet that is pre-loaded with abrasion resistant particles (typically aluminum oxide), which provide the wear and abrasion resistance to the overlay, during the paper making process. The abrasion resistant particles are mixed with the paper fibers during the paper making process. The preloaded overlay is then impregnated with thermoset resin and is pressed under heat and pressure with the core and the decorative components to create the laminate.

Recently in the field of art, a process has been developed whereby the abrasion resistant particles are applied to the overlay sheet during the impregnation process. This process is called liquid overlay. In this process, a continuous web of alpha cellulose paper is impregnated with thermoset resin, and then is coated with a slurry of abrasion resistant particles/thermoset resin. The liquid overlay process creates an overlay, which, when pressed, has far superior clarity to that of the preloaded overlay formed by the process discussed above. Clarity is desirable because it allows the decorative layer underneath the overlay to show through clearly, and the overall color of the laminate is, therefore, closer to the color that the designer of the decorative layer intended.

Despite this level of clarity, there remains the need to improve clarity, as well as to improve the scratch, wear, scuff, mar, and abrasion resistance of the laminates exposed to wear. This is especially the case with laminates for floors, desktops, and tabletops. In general terms, the known process for forming laminates is described as follows.

A continuous paper is impregnated with a thermosetting resin, such as, a melamine-formaldehyde resin. At least one side of the continuous paper is coated with a slurry which contains a certain size and quantity of small, dry and hard abrasion resistant particles evenly distributed over the whole wet surface of resin on the continuous paper. Thereafter, the resin is dried and the particle coated, impregnated paper, so-called prepreg, is cut into sheets. At least one such sheet or continuous layer is placed as an overlay on a core and bonded thereto.

The core may comprise a plurality of conventional dry or treated prepregs of continuous paper or paper sheets respectively, which are not coated with abrasion resistant particles. The resin in the uppermost of these continuous papers or paper sheets possibly comprises a thermosetting resin such as a melamine-formaldehyde resin, while the rest of the continuous papers or paper sheets preferably comprises a thermosetting resin such as phenol-formaldehyde resin or phenol-urea-formaldehyde resin. The continuous papers or pile of paper sheets are laminated continuously or discontinuously respectively with the surface layer at a high pressure and an increased temperature. Alternatively, the core may comprise particle board or fiber board, whereby the overlay may be bonded to the core by gluing or laminating under heat and pressure.

Attempts have been made to improve the abrasion and wear resistance of these laminates by the addition of the abrasion resistant particles during the production of the overlay paper of alpha-cellulose. Once added, the abrasion resistant particles are spread over a layer of wet alpha-cellulose fibers by a wire on a paper machine.

With this method, the particles are distributed more or less irregularly within the whole fiber layer. Some of these particles even pass through the wire. Thus, the abrasion resistant particles are distributed in an uncontrolled or random way on the overlay. It is very difficult by this known method to achieve an even distribution of the abrasion resistant particles on the surface of the paper. As the best effect against abrasion is achieved as a result of an even distribution of particles, in the present state of the art, the laminates obtained containing such an overlay sheet will provide uneven quality regarding abrasion resistance.

In addition, in the present state of the art, clarity of the decorative layer under the overlay is decreased and the laminate looks cloudy. Accordingly, the decorative design is not clearly visible through the laminate. This cloudy look is caused by the fact that the abrasion resistant particles are on the paper when the paper is introduced to the resin. The resin does not have sufficient saturation time to encapsulate each abrasion resistant particle; accordingly, air pockets, which distort the light and cause the milky, cloudy look, are created around the abrasion resistant particles.

### SUMMARY OF THE INVENTION

The above-described deficiencies of the prior art are overcome by an overlay formed by impregnating a substrate with a thermosetting resin and coating the substrate with a slurry comprising a thermoset resin and a mix of abrasion resistant particles, wherein the mix of abrasion resistant particles comprise a percentage of elliptical, platelet-like shaped abrasion resistant particles, wherein the percentage is based on a desired clarity. The resulting overlay demonstrates superior properties of clarity, scratch resistance, mar resistance, and abrasion resistance. Additionally, to further enhance the above-stated characteristics, the overlay may be formed with additional thermosetting resin layers, wherein the additional thermosetting resin layers are applied to the composite after the composite containing the thermoset resin and the slurry is cured. The overlay of the present invention combines liquid overlay technology with flat, platelet shaped abrasion resistant particles to create a laminate that, when pressed, has superior clarity and abrasion-, scuff- and mar-resistance.

### BRIEF DESCRIPTION OF THE DRAWINGS

FIG. 1 is a schematic depicting an exemplary process for forming an overlay;

FIG. 2 is a schematic depicting an exemplary overlay formed from the process depicted in FIG. 1;

FIG. 3 is a schematic depicting an exemplary process for forming an overlay;

FIGS. 4-7 are schematics depicting exemplary overlays formed from the process depicted in FIG. 3;

FIG. 8 is a schematic depicting an exemplary process for forming a laminate;

FIG. 9 is a schematic depicting an exemplary laminate formed from the process set forth in FIG. 8;

FIG. 10 is a photograph of prior art abrasion resistant particles; and

FIG. 11 is a photograph of an exemplary elliptical, platelet-shaped abrasion resistant particle

### DETAILED DESCRIPTION OF THE INVENTION

As described above, so far it has not been possible to avoid the above mentioned problems in a satisfactory way. However, according to the present invention, it has been possible to solve the above problems and bring about a process for the production of a decorative thermosetting laminate having improved characteristics including improved clarity, and improved abrasion resistance, scuff resistance, and mar resistance. The process includes forming an overlay comprising a substrate impregnated with a thermoset resin and coated with a slurry, wherein the slurry comprises a thermoset resin and elliptical, platelet shaped abrasion resistant particles. The resulting composite is then cured to form a cured composite. The process may further comprise applying at least one or more additional thermoset resin layers to the cured composite.

The substrate may comprise conventional overlay substrates. Accordingly, the substrate may include, for example, at least one of paper, a glass mat, mica, and the like, and may comprise one or multiple layers of these materials.

The thermoset resin used to impregnate the substrate, the thermoset resin used to form the slurry, and the additional thermoset resin(s), may comprise a wide variety of thermoset resin compositions, and may be identical to or different from each other in composition. The thermoset resin may include those thermoset resins which are conventional in the laminate industry, and which comprise, for example, at least one of phenol-melamine, melamine-formaldehyde, phenol-urea-formaldehyde-melamine, polyester-melamine, urea-formaldehyde, polyurethane, epoxy-melamine, and the like.

Accordingly, the thermoset resin may include low pressure formulations and high pressure formulations depending on whether low pressure laminates or high pressure laminates are desired. In general, high pressure formulations have a low mole ratio and low pressure formulations have a high mole ratio. The mole ratio may vary widely and constitutes the proportion between the concentration of the cross linking agent, for example, the formaldehyde, and the concentration of the thermoset agent, i.e., the melamine, in the thermoset resin, wherein the mole ratio is selected to confer certain desired characteristics onto the laminate based on the use of the laminate.

Additionally, the thermoset resin used in the process disclosed herein may comprise certain additives to increase preferable properties. For example, the additives may comprise at least one of plasticizers which control the flexibility of the surface layer, saturation agents which promote clarity, catalysts which control flexibility and aid in the curing of the surface layer, release agents which assist in production, antiblock agents which reduce blocking or sticking in the paper stack, and anti-mar and scuff additives which reduce friction on the surface of the surface layer. The additives may be added at various points in the process disclosed herein.

The slurry, which is coated on the thermoset resin that impregnates the substrate of the overlay, comprises a thermoset resin and abrasion resistant particles. The thermoset resin in the slurry may comprise those thermoset resins described above, wherein the thermoset resin that impregnates the substrate may comprise a composition that is identical to or different from the thermoset resin in the slurry with regards to both the specific agents used in the composition and the quantities of agents used in the composition.

In addition to the thermoset resin, the slurry comprises abrasion resistant particles having an elliptical, platelet-like shape. The abrasion resistant particles can comprise many different materials, wherein exemplary materials include, for example, at least one of silica, aluminum oxide, and silicon carbide. The size and shapes of the particles is important for the final result. If the particles are too big, the surface of the laminate will be rough and unpleasant. On the other hand, too small particles can give too low abrasion resistance. Accordingly, in an exemplary embodiment, the abrasion resistant particles have particle sizes ranging from about 1 to about 100 micrometers.

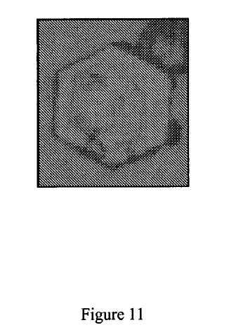

As stated above, the abrasion resistant particles comprise an elliptical, platelet like shape. An exemplary abrasion resistant particle pursuant to the present invention comprises a particle comprising an elliptical, hexagonal platelet like shape, as depicted in FIG. 11.

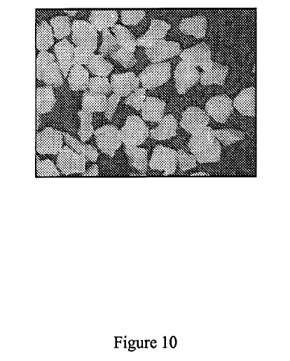

When used in conventional overlays, the conventionally used abrasion resistant particles are jagged, crystalline and spherical in shape (see, for example, FIG. 10). When pressed, the jagged, spherical shapes leave high points on the surface of the laminate. However, the elliptical, relatively flat, platelet shaped abrasion resistant particles of the present invention produce a smoother, flatter surface when pressed. This smooth surface increases the scratch- and mar-resistance of the overlay. Specifically, the platelet shape of the abrasion resistant particles is optically superior to the spherical fused type, which are depicted in FIG. 10. In an exemplary embodiment, the elliptically-shaped abrasion resistant particles have an aspect ratio of about 5:1, meaning that the elliptically-shaped particles are wide but thin. Thus it is easier to see through the platelet type of abrasion resistant particles as compared to the spherical type of abrasion resistant particles.

The shape of the abrasion resistant particles can also have an impact on press plate life. The standard spherical particles used in conventional overlays have more potential to cause premature press plate wear when the overlay is pressed as the abrasion resistant particles can act like sandpaper. The abrasion resistant particles in the overlay of the present invention, however, because they are relatively small, i.e., within the range of about 1 micrometer to about 100 micrometers, and are platelet shaped, have less potential to cause premature plate wear.

Despite the benefits of having platelet shaped abrasion resistant particles, if additional wear resistance is desired, in addition to the relatively flat, elliptical, platelet shaped abrasion resistant particles discussed above, the slurry may further comprise crystalline-shaped abrasion resistant particles, wherein it is contemplated that an unlimited matrix of combinations of shapes, sizes and concentrations of abrasion resistant particles may be used to obtain the desired characteristics in the final product. However, in an exemplary embodiment, it is contemplated that the slurry comprise at least about 5 percent of platelet shaped abrasion resistant particles, wherein the percentage is based on the total number of abrasion resistant particles contained in the slurry.

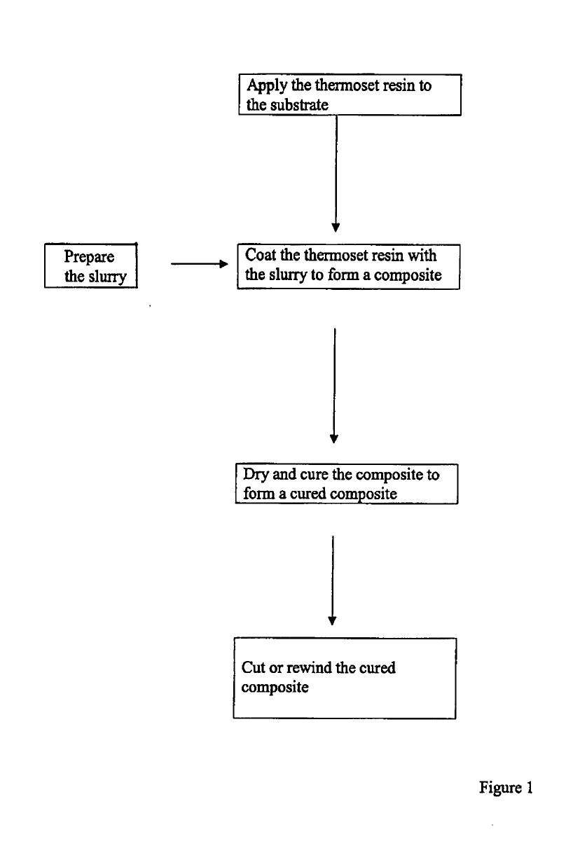

An exemplary process used to form the inventive overlay and laminate of the present invention is discussed with reference to FIG. 1. Referring to FIG. 1, the process comprises preparing a slurry having an abrasion resistant particle concentration of about 1 percent to about 50 percent, based on the total concentration of the slurry, wherein at least about 5 percent of the abrasion resistant particles comprise an elliptical, platelet-like configuration, wherein the percentage is based on the total number of abrasion resistant particles contained in the slurry. The process further comprises applying a thermoset resin to a substrate, and then applying the slurry to the substrate while the substrate is still wet from the application of the thermoset resin. In a preferred embodiment, the substrate comprises paper having a continuous web of alpha cellulose, and having a basis weight of about 10 to about 100 grams per square meter.

The way in which the slurry is applied to the impregnated substrate may be varied. However, in an exemplary embodiment, the method may comprise spraying the slurry to the substrate under pressure, as is customarily done in a fountain ARP system, and/or using a receptacle containing the slurry and a rotating doctor-roll with an uneven surface placed within or above the receptacle, as is customarily done in a Gravure system. In the Gravure system, the substrate passes through or within the receptacle and the slurry is distributed evenly on the substrate which is continuously fed through the doctor-roll.

More particularly, in the fountain ARP system, a fountain continuously sprays the slurry and utilizing an adjacent set of smooth, rotating rolls. The substrate comes in contact with the slurry as it is sprayed out of the fountain. The substrate then passes through the smooth rotating rolls where excess slurry is metered away.

The Gravure system utilizes a rotating roll which is engraved with open cells. The rotating roll has the slurry which is continuously pumped into the cells. As the substrate passes under the rotating roll, the slurry is deposited onto the substrate.

A combination of the two systems, namely a device utilizing a fountain, rolls and open cells is contemplated by this disclosure. The device may also comprise a scraper plate intended to give an even feeding of the slurry along the surface of the doctor-roll.

Other devices can be used for application of the slurry to the wet substrate. For instance, electrostatic coating can be used, as well as, for example, reverse roll technology. It is also possible to charge the abrasion resistant particles by means of friction and then apply the slurry to the thermoset resin layer on the wet substrate. This charge can be brought about, for example, by rubbing the particles against a Teflon surface.

Once the composite comprising the thermoset resin-impregnated substrate and the slurry is formed, the composite is dried and cured. After cure, the concentration of the abrasion resistant particles on the coating comprises about 0.1 grams per square meter (“gsm”) to about 50 gsm. After dry and cure, the cured composite may be cut for use as an overlay in the formation of a laminate.

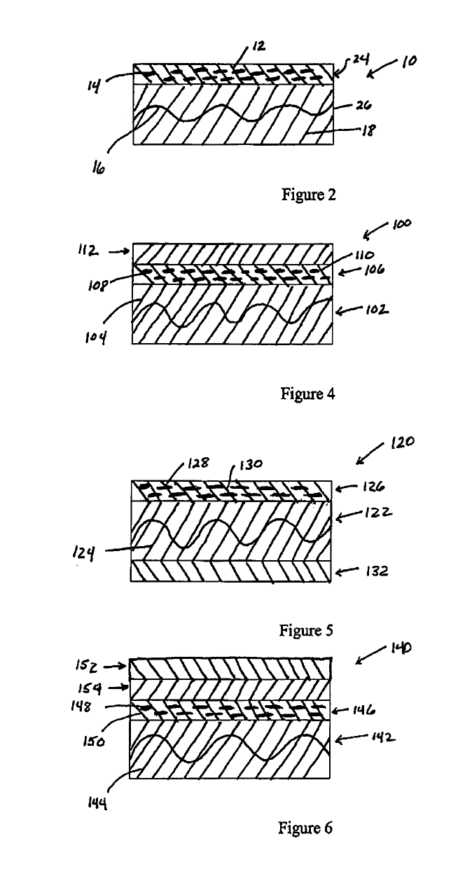

Referring to FIG. 2, an overlay 10 may be formed from the process disclosed above with reference to FIG. 1. Overlay 10 comprises a slurry coating 24 and a substrate 26. Slurry coating 24 comprises a thermoset resin 12 and a mixture of abrasion resistant particles 14. Additionally, substrate 26 comprises an alpha-cellulose web 16 and a thermoset resin 18, wherein thermoset resin 18 and thermoset resin 12 may be identical to or different from each other.

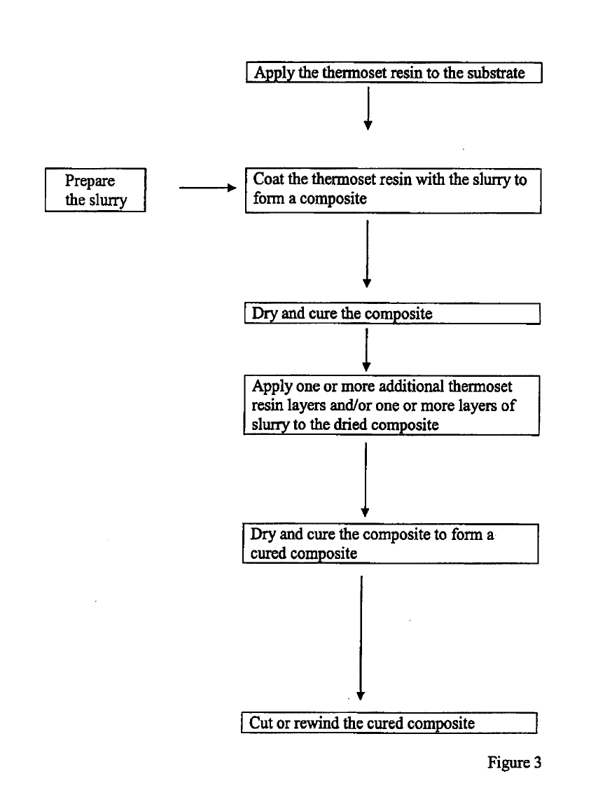

FIG. 3 depicts an exemplary method for forming another exemplary overlay, wherein the method of FIG. 3 is identical to that disclosed in FIG. 1, but also comprises applying one or more additional thermoset resin layers and/or layers of slurry to the cured composite formed according to the process set forth in FIG. 1, wherein the additional thermoset resin layers and/or additional slurry layers may comprise the same or different thermoset resin(s) and/or layers of slurry used to form the uncured composite. That is, after the initial composite is dried and cured, and prior to cutting, one or more additional thermoset resin layers and/or slurry coat(s) may be added to the cured composite. The resulting composite, now comprising the additional thermoset resin layer(s) and/or slurry coat(s), may then again be dried and cured. The resulting final cured composite may then be cut or rewound for use as an overlay in the formation of a laminate. It is contemplated that one or more of the additional thermoset resin layers may be applied to any one of the slurry coating, the substrate, or to a prior placed additional thermoset resin layer and/or additional layer of slurry. Additionally, in a particularly preferred embodiment, the additional layer of slurry, is preferably applied to at least one of the initial layer of slurry, i.e., the layer of slurry that is coated directly onto the substrate, another additional layer of slurry, or to an additional thermoset resin layer, wherein such positioning of the additional layer of slurry is preferably indirectly positioned on the same side of the substrate as the initial layer of slurry, i.e., the additional layer of slurry preferably will not be sandwiched between the substrate and the core when the laminate is formed.

An exemplary method of forming the overlay comprising one or more additional thermoset resin layers comprises impregnating a substrate with about a 5 to about a 250 gsm coating of a thermoset resin, and then coating the thermoset resin-impregnated substrate with about a 5 to about a 250 gsm coating of slurry. The thermoset resin layer and the slurry are dried and cured with sufficient time and temperature (about 80 degrees Celsius to about 200 degrees Celsius) to achieve a volatile content of about 2 percent to about 10 percent (as measured at 165 degrees Celsius for 5 minutes). This drying process forms a cured composite. After or partway through the drying process, one or more additional thermoset resin layers and/or slurry layers may be added to the composite, wherein such additional thermoset resin layers and/or slurry layers may be directly added to the dried slurry layer, directly to the substrate, and/or directly to an adjacently placed additional resin layer. After the additional layers are added, the composite is dried with sufficient time and temperature (about 80 degrees Celsius to about 200 degrees Celsius) to achieve a volatile content of about 2 percent to about 10 percent (as measured at 165 degree Celsius for 5 minutes).

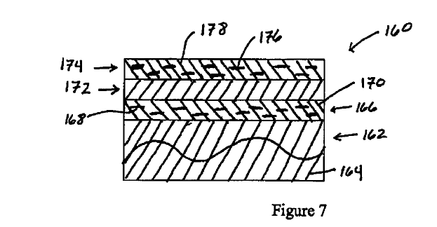

Exemplary overlays formed from the process set forth in FIG. 3 are depicted in FIGS. 4-7. Referring to FIG. 4, an overlay 100 comprises a substrate 102 impregnated with a thermoset resin 104, and having a slurry coating 106 comprising abrasion resistant particles 108 and a thermoset resin 110 disposed on a top of substrate 102. In this embodiment, overlay 100 further comprises a thermoset resin layer 112 disposed on top of slurry coating 106.

Referring to FIG. 5, an overlay 120 comprises a substrate 122 impregnated with a thermoset resin 124, and having a slurry coating 126 comprising abrasion resistant particles 128 and a thermoset resin 130 disposed on top of substrate 122. In this embodiment, overlay 120 further comprises a thermoset resin layer 132 disposed on a bottom side of substrate 122.

Referring to FIG. 6, an overlay 140 comprises a substrate 142 impregnated with a thermoset resin 144, and having a slurry coating 146 comprising abrasion resistant particles 148 and a thermoset resin 150 disposed on top of substrate 142. In this embodiment, overlay 140 further comprises two additional thermoset resin layers 152 and 154 stacked on top of slurry coating 146.

Referring to FIG. 7, an overlay 160 comprises a substrate 162 impregnated with a thermoset resin 164, and having a slurry coating 166 comprising abrasion resistant particles 168 and a thermoset resin 170 disposed on top of substrate 162. In this embodiment, overlay 160 further comprises a resin layer 172 and a slurry coating 174, wherein slurry coating 174 comprises abrasion resistant particles 176 and a thermoset resin 178, wherein abrasion resistant particles 176 and thermoset resin 178 may be identical to or different from respective abrasion resistant particles 168 and thermoset resin 170.

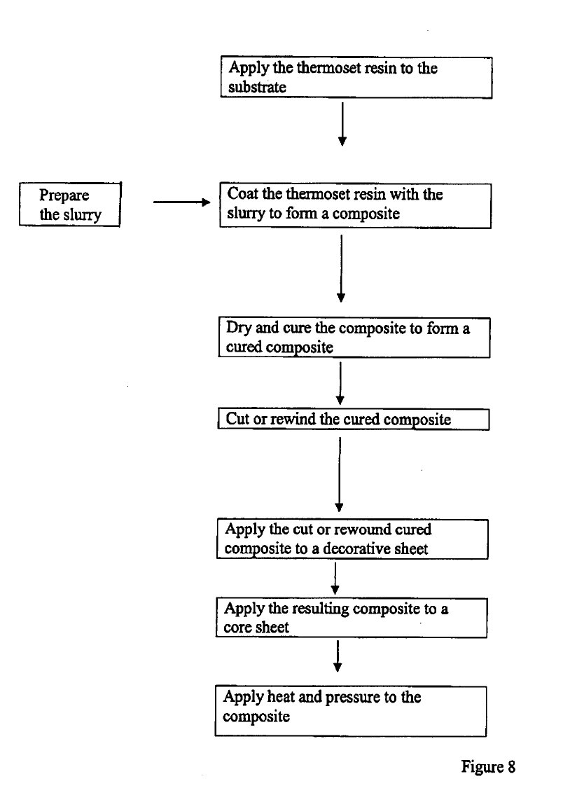

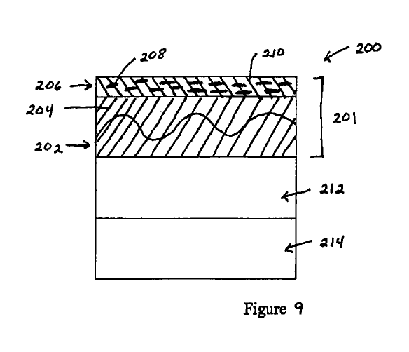

In addition to the production of a novel overlay, the invention also relates to a process for the production of a decorative thermosetting laminate having an abrasion-resistant overlay, wherein the overlay is formed according to the above-described methods. That is, referring to FIG. 8, the overlay formed from either of the methods described above may be pressed under heat of about 200 degrees Fahrenheit to about 500 degrees Fahrenheit, and a pressure of about 100 pounds per square inch to about 1,800 pounds per square inch, with core and decorative sheets to create an exemplary decorative laminate 200 as depicted in FIG. 9. Referring to FIG. 9, exemplary laminate 200 comprises an overlay 201 comprising a substrate 202 impregnated with a thermoset resin 204 and having a slurry coating 206 disposed on top thereof. Slurry coating 206 comprises abrasion resistant particles 208 and a thermoset resin 210. In addition to overlay 201, laminate 200 further comprises a decorative sheet 212, and a core 214. Preferably, laminate 200 is pressed with slurry coating 206 side up to create a protective layer on the surface of laminate 200 which provides wear resistance and superior scuff-, mar-, and scratch-resistance.

Although the present invention has been described with reference to the figures, it is to be understood that the invention is not limited thereto. Rather, the invention shall include all obvious modifications and variations to the present disclosure as would occur to one of ordinary skill in the art.

What is claimed is:

1. A method for the production of a decorative laminate having an abrasion-resistant, scuff- and mar-resistant overlay, wherein the method comprises forming an overlay, wherein the method of forming the overlay comprises:
impregnating a first side of a substrate with a first thermosetting resin;
coating the first side of the substrate with a layer of slurry comprising a second thermosetting resin and a mix of abrasion resistant particles, wherein the mix of abrasion resistant particles comprises at least about 5 percent of elliptical, platelet shaped abrasion resistant particles to form a composite; and
curing the composite to form a cured composite.

2. The method of claim 1, wherein the mix of abrasion resistant particles further comprises abrasion resistant particles having a crystalline shape.

3. The method of claim 1, wherein the first thermosetting resin comprises at least one of a melamine-formaldehyde resin, a phenol-formaldehyde resin, and a phenol-urea-formaldehyde resin.

4. The method of claim 3, wherein the second thermosetting resin comprises at least one of a melamine-formaldehyde resin, a phenol-formaldehyde resin, and a phenol-urea-formaldehyde resin.

5. The method of claim 1, wherein the substrate comprises an alpha-cellulose based paper.

6. The method of claim 1, wherein the mix of abrasion resistant particles comprises at least one of silica, aluminum oxide, and silicon carbide.

7. The method of claim 1, wherein the elliptical, platelet shaped abrasion resistant particles comprise an average particle size of about 1 to about 100 micrometers.

8. The method of claim 1, wherein the elliptical, platelet shaped abrasion resistant particles are hexagonal.

9. The method of claim 1, wherein the elliptical, platelet shaped abrasion resistant particles comprise an aspect ratio of about 5:1.

10. The method of claim 1, further comprising preparing the layer of slurry, wherein the layer of slurry comprises about 1 to about 50 percent of the abrasion resistant particles.

11. The method of claim 10, wherein the impregnating comprises impregnating the substrate with about 5 to about 250 grams per square meter of the first thermosetting resin.

12. The method of claim 11, wherein the coating the first side of the substrate comprises coating the substrate with about 5 to about 250 grams per square meter of the slurry.

13. The method of claim 1, further comprising sandwiching a decorative sheet between the overlay and a core sheet to form a unit and applying heat and pressure to the unit.

14. The method of claim 1, wherein the method of forming the overlay further comprises:
applying at least: one or more additional thermoset resin layers and one or more additional layers of slurry to the cured composite to form a second composite; and
curing the second composite.

15. The method of claim 14, wherein an additional thermoset resin layer is applied to the layer of slurry.

16. The method of claim 15, wherein an additional thermoset resin layer is applied to a side of the substrate opposite to the layer of slurry.

17. The method of claim 14, further comprising sandwiching a decorative sheet between the overlay and a core sheet to form a unit and applying heat and pressure to the unit.

18. The method of claim 14, wherein at least one or more of the elliptical, platelet shaped abrasion resistant particles are hexagonal.

19. The method of claim 14, wherein the elliptical, platelet shaped abrasion resistant particles comprise an aspect ratio of about 5:1.

20. The method of claim 14, further comprising preparing the layer of slurry, wherein the layer of slurry comprises about 1 to about 50 percent of the abrasion resistant particles.

21. The method of claim 20, wherein the impregnating comprises impregnating the substrate with about 5 to about 250 grams per square meter of the first thermosetting resin.

22. The method of claim 21, wherein the coating the first side of the substrate comprises coating the substrate with about 5 to about 250 grams per square meter of the slurry.

23. A laminate formed from the method of claim 14.

24. A laminate formed from the method of claim 1.

25. A decorative laminate exhibiting superior clarity, abrasion resistance, mar resistance, and scuff resistance, wherein the decorative laminate comprises an overlay comprising:
a substrate impregnated with a first thermoset resin; and
a slurry coating comprising a second thermoset resin and a mixture of abrasion resistant particles, wherein the mixture comprises at least about 5 percent of elliptical, platelet shaped particles.

26. The decorative laminate of claim 25, wherein the mixture further comprises crystalline shaped abrasion resistant particles.

27. The decorative laminate of claim 25, wherein at least one or more of the elliptical, platelet shaped particles are hexagonal.

28. The decorative laminate of claim 25, wherein the mixture of abrasion resistant particles comprises at least one of silica, aluminum oxide, and silicon carbide.

29. The decorative laminate of claim 25, wherein the overlay comprises about 0.1 grams per square meter to about 50 grams per square meter of the abrasion resistant particles.

30. The decorative laminate of claim 25, wherein the abrasion resistant particles comprise a size of about 1 to about 100 micrometers.

31. The decorative laminate of claim 25, wherein the overlay filter comprises at least one of: one or more additional thermoset resin layers, and one or more additional layers of slurry.
